(19) United States
(12) Patent Application Publication
(10) Pub. No.: US 2014/0126237 A1
(43) Pub. Date: May 8, 2014

(54) SURFACE LIGHT SOURCE DEVICE

(71) Applicant: Kabushiki Kaisha Toshiba, Minato-ku (JP)

(72) Inventors: Takeshi MORINO, Yokohama-shi (JP); Masataka Shiratsuchi, Kawasaki-shi (JP)

(73) Assignee: Kabushiki Kaisha Toshiba, Minato-ku (JP)

(21) Appl. No.: 14/068,167

(22) Filed: Oct. 31, 2013

(30) Foreign Application Priority Data
Nov. 5, 2012 (JP) 2012-243885

(51) Int. Cl. F21V 8/00

(52) U.S. Cl. CPC G02B 6/0011
USPC 362/607; 362/606

(57) ABSTRACT

According to one embodiment, a surface light source device includes following elements. The light guide plate includes a flat portion and a curved portion. The light guide plate further includes an end surface to introduce light which is located on a side of the curved portion, a light diffusing portion to diffuse the light introduced from the end surface, and a light-emitting surface to output the light diffused by the light diffusing portion. The light-emitting unit is to generate the light toward the end surface. The housing is to house the light guide plate and the light-emitting unit. The fixing portion is to fix the light guide plate to the housing, the fixing portion being arranged in contact with the curved portion.

### CROSS REFERENCE TO RELATED APPLICATIONS

This application is based upon and claims the benefit of priority from Japanese Patent Application No. 2012-243885, filed Nov. 5, 2012, the entire contents of which are incorporated herein by reference.

### FIELD

Embodiments described herein relate generally to a surface light source device using a light guide plate.

### BACKGROUND

In recent years, using a liquid crystal display (LCD) device as a large and flat television apparatus is becoming widespread. The LCD device cannot emit light by itself and therefore includes a surface light source device (backlight).

As the backlight used in the LCD device, an edge-light type backlight is known. The edge-light type backlight introduces, from the side edge surface of a rectangular flat light guide plate, light generated by a light source, and outputs it from the light-emitting surface of the light guide plate. The edge-light type backlight is advantageous in terms of reducing the thickness of a housing, compared to a direct type backlight which includes a light source opposed to the back surface of a liquid crystal panel and directly illuminates the liquid crystal panel.

In the edge-light type backlight, however, a light source is arranged opposite to the side edge surface of the light guide plate, that is, a light source is housed in the frame part of the housing, thus disadvantageously requiring a housing having a large frame part.

### BRIEF DESCRIPTION OF THE DRAWINGS

FIG. 1 is a side-sectional view schematically showing a surface light source device according to the first embodiment;

FIG. 2 is a side-sectional view showing an example in which a light guide plate fixing portion shown in FIG. 1 is provided with a light reflecting portion;

FIG. 3 is a side-sectional view schematically showing another example of the light guide plate fixing portion according to the first embodiment;

FIG. 4 is a side-sectional view schematically showing still another example of the light guide plate fixing portion according to the first embodiment;

FIG. 5 is a side-sectional view schematically showing still another example of the light guide plate fixing portion according to the first embodiment;

FIG. 6 is a side-sectional view schematically showing still another example of the light guide plate fixing portion according to the first embodiment;

FIG. 7 is a side-sectional view schematically showing still another example of the light guide plate fixing portion according to the first embodiment;

FIG. 8 is a side-sectional view schematically showing still another example of the light guide plate fixing portion according to the first embodiment;

FIG. 9 is a side-sectional view showing an example in which the surface light source device shown in FIG. 1 is provided with a luminance control sheet;

FIG. 10 is a side-sectional view schematically showing a surface light source device according to the second embodiment;

FIG. 11 is a side-sectional view schematically showing another example of a light guide plate fixing portion according to the second embodiment;

FIG. 12 is a side-sectional view schematically showing still another example of the light guide plate fixing portion according to the second embodiment;

FIG. 13 is a side-sectional view schematically showing still another example of the light guide plate fixing portion according to the second embodiment;

FIG. 14 is a side-sectional view schematically showing still another example of the light guide plate fixing portion according to the second embodiment;

FIG. 15 is a side-sectional view schematically showing still another example of the light guide plate fixing portion according to the second embodiment;

FIG. 16 is a side-sectional view showing an example in which the surface light source device shown in FIG. 10 is provided with a luminance control sheet;

FIG. 17 is a perspective view schematically showing a surface light source device according to the third embodiment;

FIGS. 18A and 18B are plan views showing a light guide plate according to the third embodiment; and

FIGS. 19A and 19B are plan views showing an example in which the light guide plate shown in FIG. 17 is provided with a light reflecting portion.

### DETAILED DESCRIPTION

In general, according to one embodiment, a surface light source device comprises a light guide plate, a light-emitting unit, a housing, and a fixing portion. The light guide plate comprises a flat portion and a curved portion. The light guide plate further comprises an end surface to introduce light which is located on a side of the curved portion, a light diffusing portion provided on the flat portion and the curved portion to diffuse the light introduced from the end surface, and a light-emitting surface to output the light diffused by the light diffusing portion. The light-emitting unit is to generate the light toward the end surface. The housing is to house the light guide plate and the light-emitting unit. The fixing portion is to fix the light guide plate to the housing, the fixing portion being arranged in contact with the curved portion.

Surface light source devices according to the embodiments will hereinafter be described with reference to the accompanying drawings. Each of the surface light source devices can be used as, for example, a backlight of a liquid crystal display (LCD) device, lighting equipment, or the like. In the embodiments, an example in which the surface light source device is used as the backlight of an LCD device will be explained. In this case, the surface light source device is arranged such that its light-emitting surface is opposed to the back surface of a liquid crystal panel.

### First Embodiment

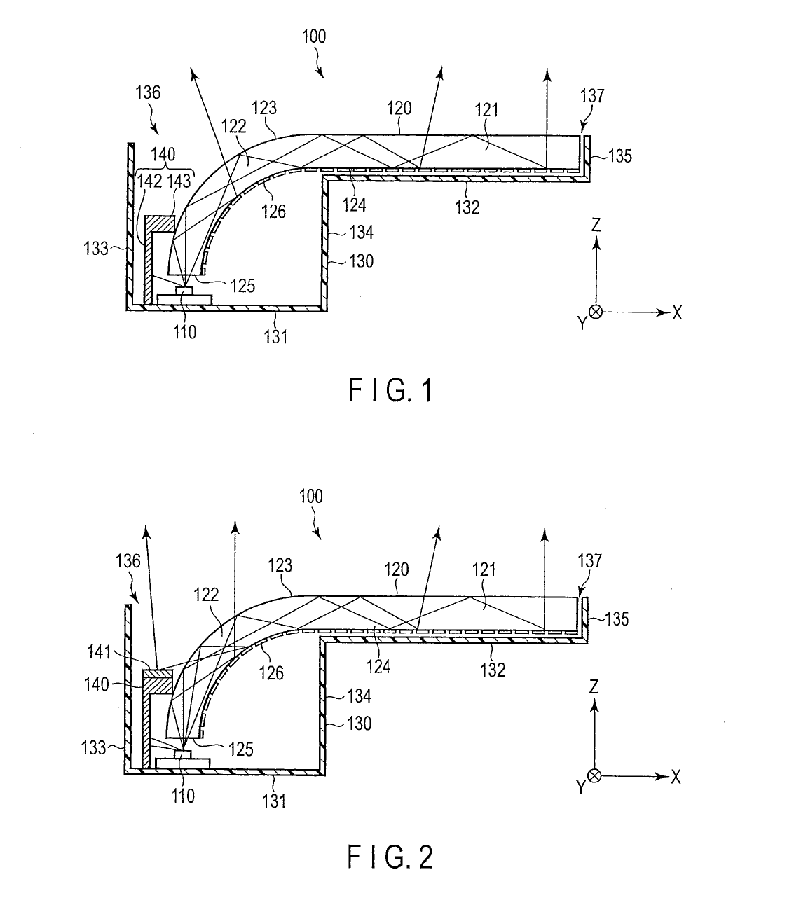

FIG. 1 is a side-sectional view schematically showing a surface light source device 100 according to the first embodiment. As shown in FIG. 1, the surface light source device 100 includes a light-emitting unit 110 corresponding to a light source, a light guide plate 120, a housing (to be also referred to as a back cover) 130, and a light guide plate fixing portion (to be also simply referred to as a fixing portion) 140. The light-emitting unit 110 is fixed on the housing 130. The light-emitting unit 110 is arranged opposite to one end surface 125 of the light guide plate 120 and generates light toward the end surface 125. The light-emitting unit 110 can be a light-emitting element array in which a plurality of light-emitting elements for emitting light (for example, white light) are arrayed in a line along the end surface 125. In this case, for example, a light-emitting diode (LED) is usable as the light-emitting element.

The light guide plate 120 is formed in a shape obtained by curving the end part of a rectangular flat plate. More specifically, the light guide plate 120 includes a flat portion 121 and a curved portion 122. The light guide plate 120 is supported in the housing 130 by members (not shown) and fixed to the housing 130 by the light guide plate fixing portion 140. The light guide plate fixing portion 140 is in contact with the curved portion 122 of the light guide plate 120. Transparent glass, a transparent resin, or the like is usable as the material of the light guide plate 120. As the transparent resin, for example, an acrylic resin, a polycarbonate resin, or the like is usable.

An XYZ rectangular coordinate system is defined, as shown in FIG. 1, for descriptive convenience. The direction of the thickness of the flat portion 121 of the light guide plate 120 is defined as the Z-direction, the direction in which the light-emitting elements of the light-emitting unit 110 are arrayed as the Y-direction, and a direction perpendicular to the Y- and Z-directions as the X-direction. When the surface light source device 100 is used as the backlight of an LCD device, the X-direction corresponds to the horizontal direction (or left/right direction), and the Y-direction corresponds to the vertical direction (or up/down direction).

The cross-section of the flat portion 121 taken along any virtual plane perpendicular to the Y-direction has a rectangular shape. Also, the cross-section of the curved portion 122 taken along any virtual plane perpendicular to the Y-direction has an at least partially curved shape or a shape having a curved part. More specifically, the sectional shape of the curved portion 122 is approximate to an arc having a central angle of about 90°, and has almost the same thickness as the flat portion 121. The light guide plate 120 also includes two major surfaces 123 and 124 opposed to each other, and four end surfaces arranged between the major surfaces 123 and 124. Out of these end surfaces, the end surface 125 located on the side of the curved portion 122 serves as a light incident surface to introduce light generated by the light-emitting unit 110. In this embodiment, the major surface 123 that faces the liquid crystal panel (not shown) when the surface light source device 100 is arranged facing the liquid crystal panel will be referred to as a light-emitting surface, and the other major surface 124 will be referred to as a back surface.

Light generated by the light-emitting unit 110 enters the light guide plate 120 through the end surface 125 of the curved portion 122 and propagates through the light guide plate 120 while repeating total reflection. The light propagating through the light guide plate 120 is diffused by a light diffusing pattern (to be also referred to as a light diffusing portion) 126 provided on the back surface 124 of the light guide plate 120, and is output outside the light guide plate 120 from the light-emitting surface 123. The light diffusing pattern 126 is provided on the flat portion 121 and the curved portion 122. In the flat portion 121, the light diffused by the light diffusing pattern 126 exits mainly in the Z-direction. In the curved portion 122, the light diffused by the light diffusing pattern 126 radially exits along the radius of the arc-like shape that is the sectional shape of the curved portion 122. This makes it possible to obtain light to irradiate the liquid crystal panel not only immediately above the curved portion 122 (Z-direction) but also immediately above the light guide plate fixing portion 140 (Z-direction). The light from the light-emitting unit 110 thus exits as the illumination light of the surface light source device 100.

To form the light diffusing pattern 126, for example, a method of performing dot printing using white silk-screen printing, a method of forming a minute concavities and convexities at the time of molding of the light guide plate 120, or a method of forming a minute concavities and convexities using laser beam machining after molding of the light guide plate 120 is usable. Note that the light diffusing pattern 126 need not always be provided on the back surface 124 of the light guide plate 120 but may be formed from fine particles having light diffusing properties and added inside the light guide plate 120.

The light-emitting unit 110 and the light guide plate 120 are housed in the housing 130. The housing 130 is formed into a shape conforming to the shape of the light guide plate 120. More specifically, the housing 130 is formed such that the region to house the flat portion 121 becomes thinner than the region to house the curved portion 122. The light-emitting unit 110 and the curved portion 122 are located in a space formed by a back portion 131 and side portions 133 and 134 of the housing 130. The flat portion 121 is located in a space formed by a back portion 132 and a side portion 135 of the housing 130. The housing 130 has an opening 136 at a portion facing the light-emitting surface 123 of the light guide plate 120. In a conventional edge-light type backlight, the light source is arranged at a side portion of the housing. Hence, a space to house the light source is needed in the frame part (i.e., bezel) of the housing. In this embodiment, the light-emitting unit 110 is arranged on the back portion 131 of the housing 130. It is therefore possible to make a frame part 137 of the housing 130 small or narrow or completely eliminate the frame part 137 of the housing 130.

The light guide plate fixing portion 140 has, for example, a hook-shaped or L-shaped section. The sectional shape here indicates that obtained along the X-Z plane. More specifically, the light guide plate fixing portion 140 includes a base 142 bonded to the back portion 131 of the housing 130, and a projecting portion 143 integrated with the base 142. In the example of FIG. 1, each of the base 142 and the projecting portion 143 has a rectangular section. The projecting portion 143 of the light guide plate fixing portion 140 is in contact with the curved portion 122 of the light guide plate 120. For example, the light guide plate 120 may be attached to the light guide plate fixing portion 140 by fitting a convex portion (not shown) formed on the curved portion 122 in a concave portion (not shown) formed in the projecting portion 143. The projecting portion 143 of the light guide plate fixing portion 140 comes into contact with the curved portion 122 of the light guide plate 120, thereby preventing the light guide plate 120 from shifting to the liquid crystal panel side (Z-direction). This can maintain a predetermined distance between the light-emitting unit 110 and the end surface 125 of the light guide plate 120. It is consequently possible to obtain a stable luminance and spatial luminance distribution independently of the use direction of the surface light source device 100. In addition, using the light guide plate fixing portion 140 makes it possible to reduce assembly errors between the light-emitting unit 110 and optical components such as the light guide plate 120. Note that the light guide plate fixing portion 140 can be either separated from the housing 130 or integrated with the housing 130.

A part of the light generated by the light-emitting unit 110 may leak in the lateral direction without entering the end surface 125 of the light guide plate 120. This leakage light may be reflected or diffused in the housing 130 and directly exit to the liquid crystal panel side (Z-direction). The leakage light relatively has a very high luminance as compared to the light diffused by the light diffusing pattern 126 and exiting from the light guide plate 120, and can lead to nonuniformity of the spatial luminance distribution of illumination light of the surface light source device 100. In this embodiment, the light guide plate fixing portion 140 is used as a light blocking portion for blocking the leakage light. The light guide plate fixing portion 140 is arranged near the curved portion 122 so as to block the leakage light from the light-emitting unit 110, thereby facilitating uniforming the spatial luminance distribution.

Although the light guide plate fixing portion 140 can be made of any material, a material having high light absorptance is preferably used. For example, the light guide plate fixing portion 140 is formed from a black plastic. Note that the light guide plate fixing portion 140 need only have a surface processed by a material having high light absorptance. For example, the light guide plate fixing portion 140 may have a surface on which black alumite treatment is performed. Alternatively, the light guide plate fixing portion 140 may partially or wholly have a black tape or black coating. Using a material having high light absorptance to form or process the light guide plate fixing portion 140 makes it possible to enhance the performance of blocking, out of the light generated by the light-emitting unit 110, light components that leak in the lateral direction without entering the end surface 125 of the light guide plate 120.

Out of the surface of the light guide plate fixing portion 140, a portion facing the liquid crystal panel (not shown) may be provided with a light reflecting portion 141 to reflect light, as shown in FIG. 2. As the light reflecting portion 141, it is possible to use a member such as a metal mirror or glass mirror that causes mirror reflection of light, a member such as a white reflecting sheet that causes diffused reflection of light, or the like. The light reflecting portion 141 may be formed by applying a white coating to the surface of the light guide plate fixing portion 140 to implement a light reflecting function. When the light reflecting portion 141 is provided, the light that has exited from the curved portion 122 of the light guide plate 120 can partially be reflected to the liquid crystal panel side (Z-direction) and reused as illumination light.

In the example of FIG. 2, since the light guide plate fixing portion 140 is arranged near the curved portion 122 so as to block the leakage light from the light-emitting unit 110, uniformity of the spatial luminance distribution can be obtained. In addition, since the light reflecting portion 141 is provided on the surface portion of the light guide plate fixing portion 140 facing the liquid crystal panel, the light that has exited from the curved portion 122 can partially be reused. That is, the uniformity of the spatial luminance distribution and a high light use efficiency can simultaneously be obtained.

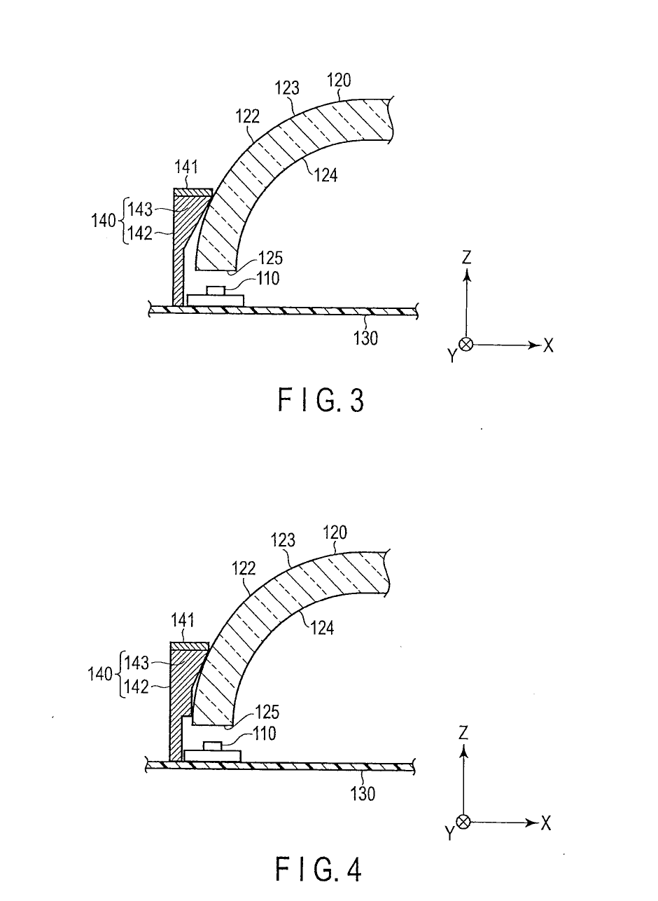

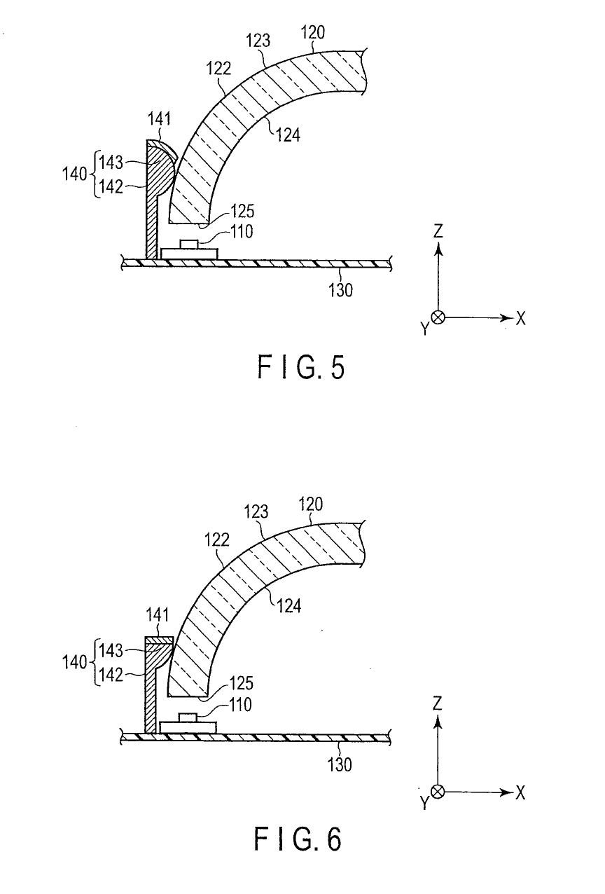

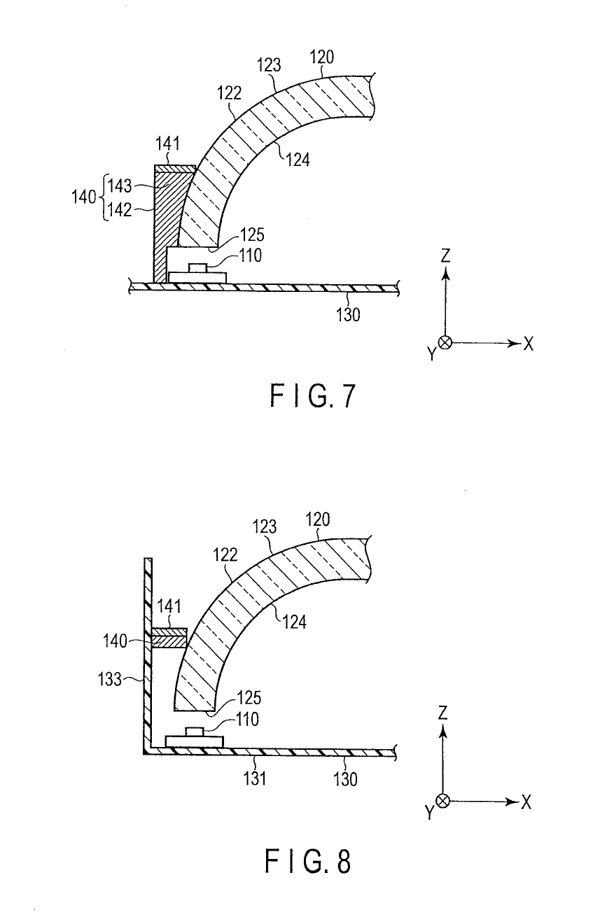

The sectional shape of the light guide plate fixing portion 140 is not limited to the hook-shape as shown in FIG. 1. FIGS. 3, 4, 5, 6, 7, and 8 show other examples of the light guide plate fixing portion 140. FIGS. 3, 4, 5, 6, 7, and 8 are partially enlarged views of the surface light source device 100. In the example shown in FIG. 3, the projecting portion 143 of the light guide plate fixing portion 140 has a triangular section. In this example, the surface of the light guide plate fixing portion 140, which is in contact with the curved portion 122, tilts with respect to the Z-direction. In the example shown in FIG. 4, the projecting portion 143 has a plurality of surfaces that tilt with respect to the Z-direction. The light guide plate fixing portion 140 is in contact with the curved portion 122 with these surfaces. In the example shown in FIG. 5, the projecting portion 143 has an almost semicircular section. The outer periphery of the projecting portion 143 is in contact with the light-emitting surface 123 of the curved portion 122. In the example shown in FIG. 6, the projecting portion 143 has a quadrant section with a plane perpendicular to the Z-direction. In the example shown in FIG. 7, the projecting portion 143 is formed so as to have a surface conforming to the light-emitting surface 123 of the curved portion 122. In the example shown in FIG. 8, the light guide plate fixing portion 140 is formed integrally with the side portion 133 of the housing 130. In all of these examples, the same effect as that of the hook-shaped light guide plate fixing portion 140 as shown in FIG. 1 can be obtained.

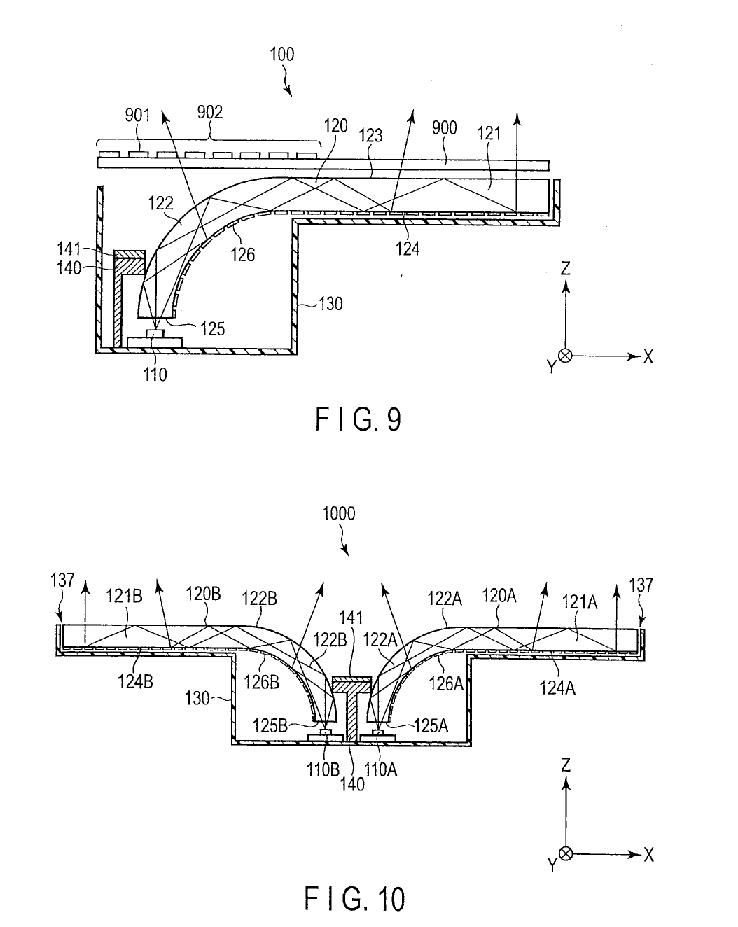

When the surface light source device 100 is used as the backlight of an LCD device, higher uniformity of the spatial luminance distribution may be required. As shown in FIG. 9, the surface light source device 100 may further include a luminance control sheet (to be also referred to as a luminance control portion) 900 that controls the luminance of light that has exited from the light-emitting surface 123. The luminance control sheet 900 is provided with a light diffusion region 902 where light diffusion dots 901 for diffusing light are formed. To form the light diffusion dots 901, for example, a method using silk-screen printing, a method of forming three-dimensional dots using a high power laser, or a method of bonding silver foil dots is usable. Alternatively, the light diffusion dots 901 may be formed by combining these methods.

In the light diffusion region 902, the dot size or dot pitch is changed at the position of the individual light diffusion dots 901, that is, the density of the light diffusion dots 901 is changed, thereby changing the spatial light transmittance. When the luminance control sheet 900 having a plurality of regions with a plurality of light transmittances in a plane is provided, the spatial luminance distribution of the illumination light of the surface light source device 100 can finely be controlled, and higher uniformity of the spatial luminance distribution can easily be obtained.

As described above, according to the surface light source device 100 of the first embodiment, the light-emitting unit (light source) 110 is arranged on the side of the back surface 124 of the light guide plate 120. It is therefore possible to make the frame part (i.e., bezel) 137 of the housing 130 narrow or completely eliminate the frame part 137 of the housing 130. Hence, even in an LCD device that uses the surface light source device 100 as a backlight, the frame part of the housing can be made narrow. When the frame part becomes narrow with respect to the screen size, for example, the screen size can be perceived relatively large. That is, the LCD device can have a more excellent design.

In addition, since the light guide plate fixing portion 140 that fixes the light guide plate 120 to the housing 130 is provided, a predetermined distance can be maintained between the light-emitting unit 110 and the end surface 125 of the light guide plate 120. Furthermore, since the light guide plate fixing portion 140 is provided, leakage light from the light-emitting unit 110 can be blocked. It is consequently possible to obtain a stable luminance and spatial luminance distribution.

### Second Embodiment

FIG. 10 is a side-sectional view schematically showing a surface light source device 1000 according to the second embodiment. The surface light source device 1000 shown in FIG. 10 is formed by combining two surface light source devices 100 shown in FIG. 1 in bilateral symmetry. The same reference numbers as in FIG. 1 denote the same elements in FIG. 10, and a description thereof will be omitted. Suffixes (A and B) are added to distinguish elements provided in bilateral symmetry in FIG. 10.

In this embodiment, a light guide plate fixing portion 140 has a T-shaped section and fixes left and right light guide plates 120A and 120B. The function of the light guide plate fixing portion 140 shown in FIG. 10 is the same as that described in the first embodiment. The function of a light reflecting portion 141 provided on the light guide plate fixing portion 140 is also the same as that described in the first embodiment. Hence, a detailed description will be omitted here.

Light generated by a light-emitting unit 110A enters light guide plate 120A through an end surface 125A of light guide plate 120A located on the side of a curved portion 122A and propagates while repeating total reflection, as shown in FIG. 10. The light propagating through light guide plate 120A is diffused by a light diffusing pattern 126A, and exits in the Z-direction from a light-emitting surface 123A of light guide plate 120A. Similarly, light generated by a light-emitting unit 110B enters light guide plate 120B through an end surface 125B of light guide plate 120B located on the side of a curved portion 122B and propagates while repeating total reflection. The light propagating through light guide plate 120B is diffused by a light diffusing pattern 126B, and exits in the Z-direction from a light-emitting surface 123B of light guide plate 120B. The light that has exited from light guide plates 120A and 120B forms the illumination light of the surface light source device 1000 and is directed to a liquid crystal panel or an optical sheet such as a diffusion sheet or a prism sheet that forms a liquid crystal panel.

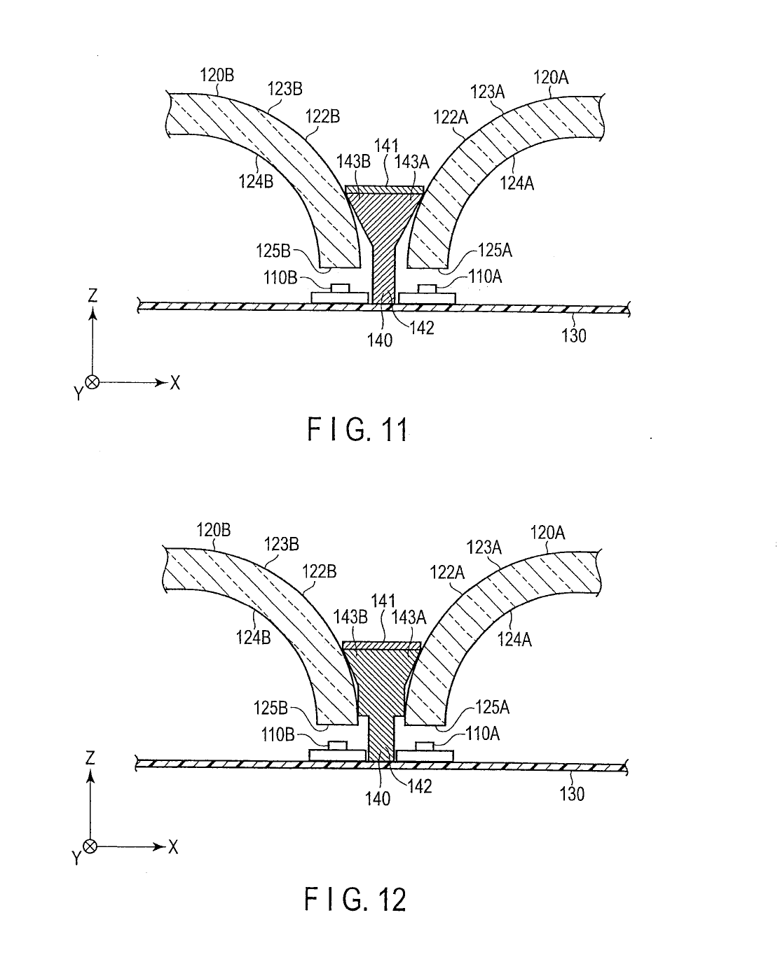

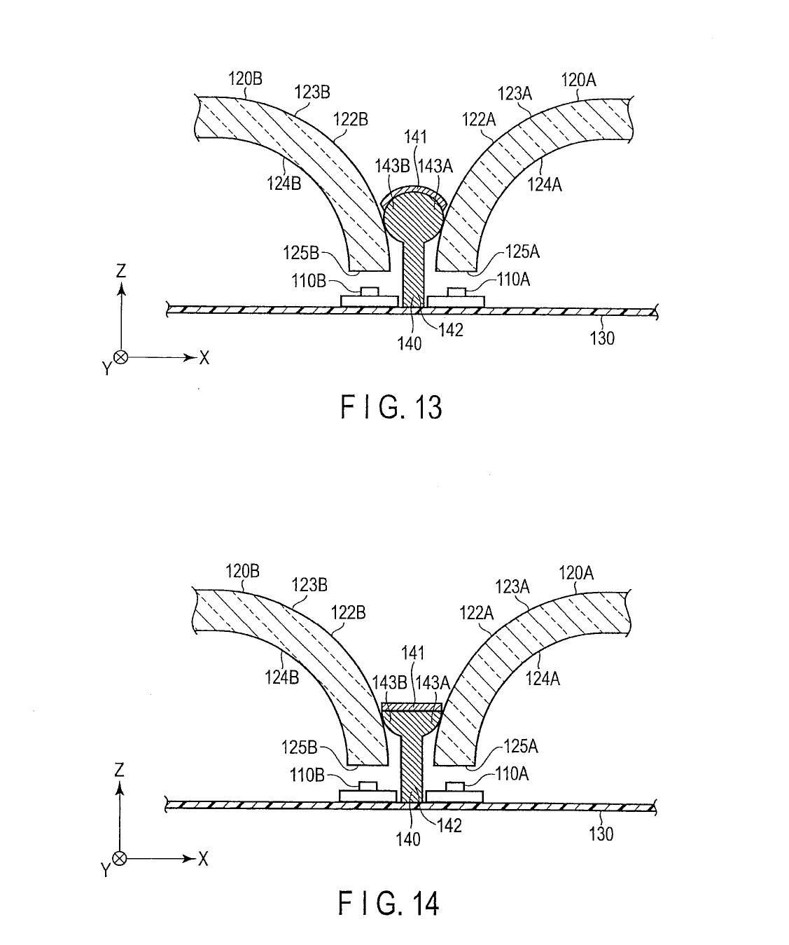

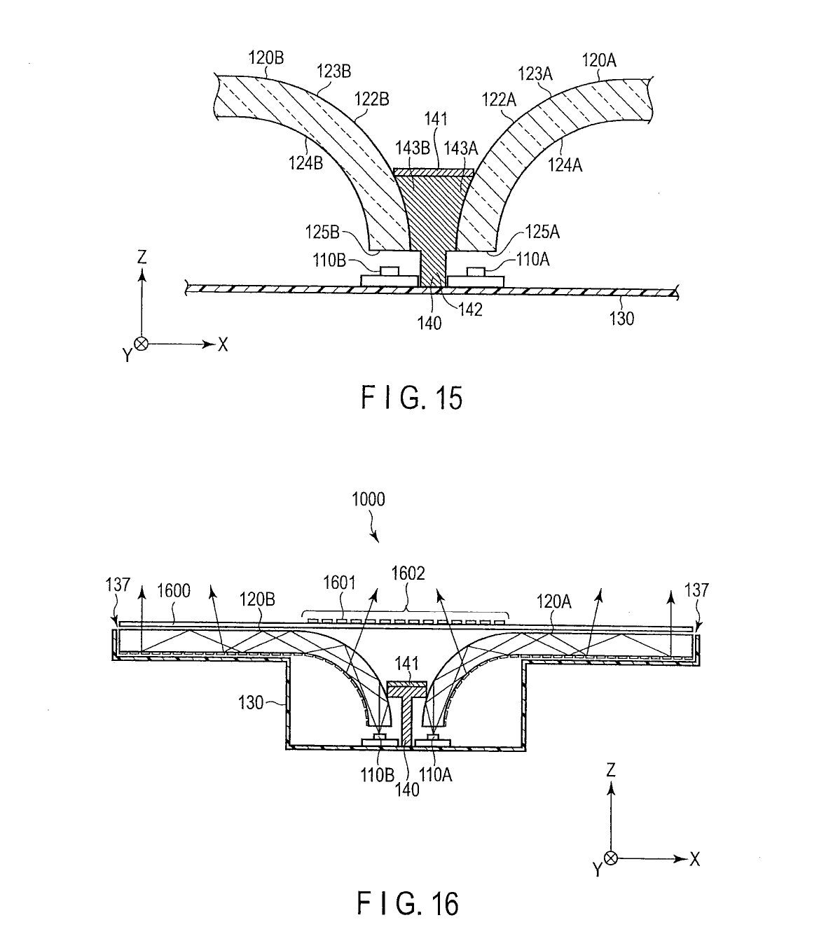

Note that the sectional shape of the light guide plate fixing portion 140 according to this embodiment is not limited to the T-shape shown in FIG. 10. FIGS. 11, 12, 13, 14, and 15 show other examples of the light guide plate fixing portion 140. FIGS. 11, 12, 13, 14, and 15 are partially enlarged views of the surface light source device 1000. In the example shown in FIG. 11, each of projecting portions 143A and 143B has a triangular section. In this example, the surface of projecting portion 143A that is in contact with curved portion 122A and the surface of projecting portion 143B that is in contact with curved portion 122B tilt with respect to the Z-direction. In the example shown in FIG. 12, each of projecting portions 143A and 143B has a plurality of surfaces that tilt with respect to the Z-direction. The light guide plate fixing portion 140 is in contact with curved portions 122A and 122B with these surfaces. In the example shown in FIG. 13, each of projecting portions 143A and 143B has an almost semicircular section. The outer peripheries of projecting portions 143A and 143B are in contact with curved portions 122A and 122B, respectively. In the example shown in FIG. 14, each of projecting portions 143A and 143B has a quadrant section with a plane perpendicular to the Z-direction. In the example shown in FIG. 15, projecting portions 143A and 143B are formed so as to have surfaces conforming to the sectional shapes of curved portions 122A and 122B, respectively.

The surface light source device 1000 may also further include a luminance control sheet 1600 that controls the luminance of light that has exited from light-emitting surfaces 123A and 123B, as shown in FIG. 16. The luminance control sheet 1600 is provided with a light diffusion region 1602 where light diffusion dots 1601 are formed. The luminance control sheet 1600 has a plurality of regions with a plurality of light transmittances in a plane. The luminance control sheet 1600 has the same arrangement as the luminance control sheet 900 shown in FIG. 9, and a detailed description thereof will be omitted. Since the surface light source device 1000 includes the luminance control sheet 1600 having regions with light transmittances, a luminance distribution having higher uniformity can be obtained.

As described above, according to the surface light source device 1000 of the second embodiment, the light-emitting unit 110 is arranged on the side of a back surface 124 of the light guide plate 120, and it is therefore possible to make a frame part (i.e., bezel) 137 of a housing 130 narrow or completely eliminate the frame part 137 of the housing 130 as in the first embodiment. Hence, even in an LCD that uses the surface light source device 1000 as a backlight, the bezel portion of the housing can be made narrow. When the bezel becomes narrow with respect to the screen size, for example, the screen size can be perceived relatively large. That is, the LCD can have a more excellent design.

In addition, in the LCD device that uses the surface light source device 1000 as a backlight, light-emitting units 110A and 110B are arranged at the center of the screen. It is therefore possible, in the LCD device, not only to narrow the frame part 137 of the housing 130 but also to thin the peripheral portion of the housing 130. When light-emitting units 110A and 110B are arranged along the vertical direction of the screen of the LCD device, the left and right regions of the peripheral portion of the housing can be made extremely thin. When light-emitting units 110A and 110B are arranged sideways along the horizontal direction of the screen of the LCD, the upper and lower regions of the peripheral portion of the housing can be made extremely thin. This can implement an LCD device that has a more excellent design that makes the LCD device appear thin and lightweight as a whole.

Furthermore, according to the surface light source device 1000 of the second embodiment, the uniformity of the luminance distribution and a high light use efficiency can easily simultaneously be obtained, as in the first embodiment. Also, using the light guide plate fixing portion 140 makes it possible to reduce assembly errors between the light-emitting unit 110 and optical components such as the light guide plate 120.

### Third Embodiment

The third embodiment is different from the second embodiment in the shape of the light guide plate. In the third embodiment, parts different from the second embodiment will be described, and a description of the same parts as in the second embodiment will be omitted.

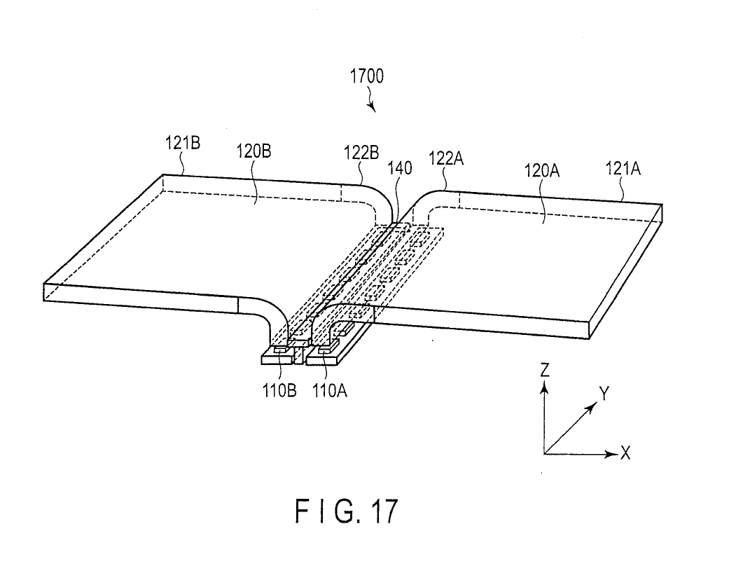

FIG. 17 is a perspective view schematically showing a surface light source device 1700 according to the third embodiment. The housing is not illustrated in FIG. 17. In this case as well, as in FIG. 1, an XYZ rectangular coordinate system is defined, as shown in FIG. 17, for descriptive convenience. The surface light source device 1700 shown in FIG. 17 includes a light guide plate 120A including a curved portion 122A with side portions obliquely cut, and a light guide plate 120B including a curved portion 122B with side portions obliquely cut.

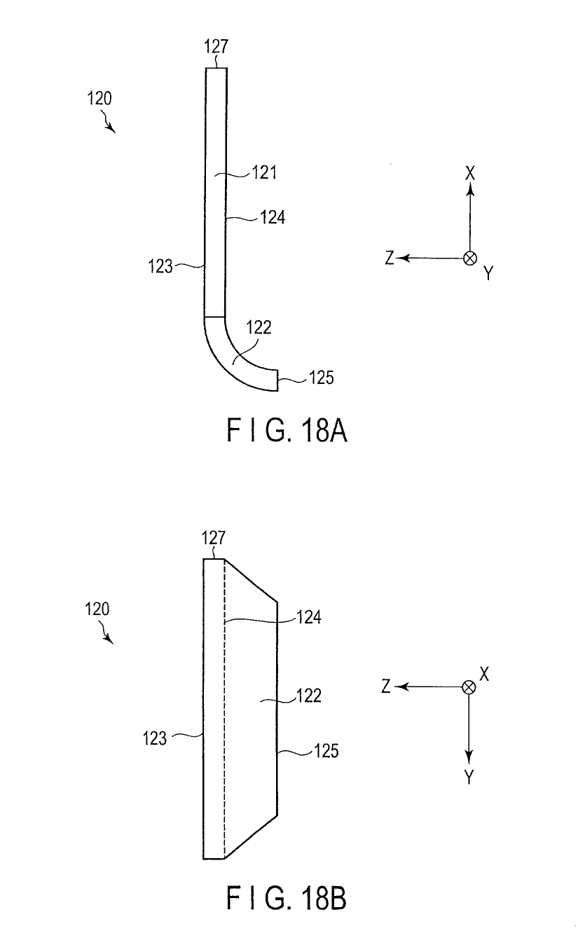

For an explanation to easily understand the structure of the light guide plate 120 (corresponding to each of light guide plates 120A and 120B shown in FIG. 17), FIGS. 18A and 18B shows the light guide plate 120 viewed from two directions. FIG. 18A is a plan view showing the light guide plate 120 viewed from the Y-direction, and FIG. 18B is a plan view showing the light guide plate 120 viewed from the X-direction. The planar shape of the light guide plate 120 viewed from the Y-direction is the same as that of the light guide plate 120 described in the first embodiment, as shown in FIG. 18A. On the other hand, in the planar shape viewed from the X-direction, two corners of the curved portion 122 are obliquely cut, as shown in FIG. 18B. That is, the curved portion 122 becomes narrow toward the end surface 125 corresponding to the light incident surface. In this case, the area of the end surface 125 is smaller than the area of an end surface 127 on the side of a flat portion 121. Accordingly, a housing 130 can also have a shape with corners obliquely cut along the side portions of the curved portion 122. Hence, the housing 130 can be made thinner. For this reason, in an LCD using the surface light source device 1700, the whole peripheral portion of the housing of the LCD can be made extremely thin. This can implement an LCD that has a more excellent design that makes the LCD appear thin and lightweight as a whole.

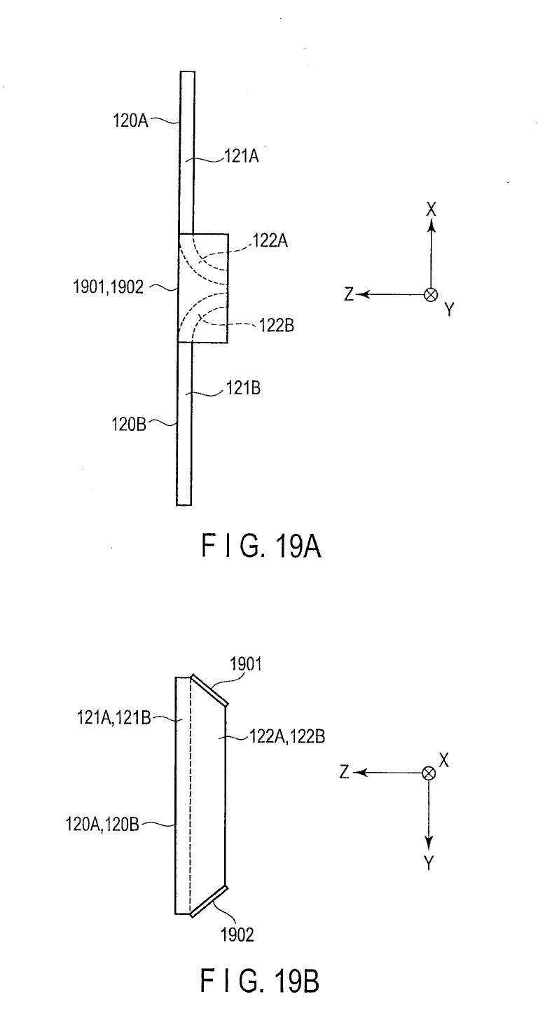

Note that in the surface light source device 1700, since the corners of curved portions 122A and 122B are obliquely cut, the luminance may change, and the spatial luminance distribution may accordingly become uneven. To prevent the unevenness of the spatial luminance distribution, light reflecting portions 1901 and 1902 may be provided on the side portions of light guide plates 120A and 120B, as shown in FIGS. 19A and 19B. As the member forming light reflecting portions 1901 and 1902, a white diffused-reflecting member or a mirror-reflecting member such as a metal mirror or a glass mirror can be used.

As described above, according to the surface light source device 1700 of the third embodiment, the side portions of curved portion 122A of light guide plate 120A and the side portions of curved portion 122B of light guide plate 120B are cut, thereby making the housing 130 thinner. As a result, the LCD device using the surface light source device 1700 can have a more excellent design.

According to at least one of the above-described embodiments, the light-emitting unit (light source) is arranged on the back surface side of the light guide plate. It is therefore possible to make the frame part (i.e., bezel) of the housing small or narrow.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A surface light source device comprising:
a light guide plate comprising a flat portion and a curved portion, the light guide plate further comprising an end surface to introduce light which is located on a side of the curved portion, a light diffusing portion provided on the flat portion and the curved portion to diffuse the light introduced from the end surface, and a light-emitting surface to output the light diffused by the light diffusing portion;
a light-emitting unit to generate the light toward the end surface;
a housing to house the light guide plate and the light-emitting unit; and
a fixing portion to fix the light guide plate to the housing, the fixing portion being arranged in contact with the curved portion.

2. The device according to claim 1, wherein the fixing portion blocks light which is generated by the light-emitting unit and leaks without entering the light guide plate.

3. The device according to claim 2, wherein the fixing portion is formed or processed by a material having high light absorptance.

4. The device according to claim 1, further comprising a luminance control sheet to control a luminance of the light output from the light-emitting surface, the luminance control sheet comprising regions with different light transmittances.

5. The device according to claim 1, wherein the light-emitting unit comprises a light-emitting element array in which a plurality of light-emitting elements are arrayed in a line along the end surface.

6. The device according to claim 1, further comprising a light reflecting portion to reflect light which is provided on part of a surface of the fixing portion.

7. The device according to claim 1, wherein the curved portion is formed to narrow toward the end surface.

8. The device according to claim 1, wherein the flat portion has a rectangular section, and the curved portion has a curved sectional shape.
